(19) United States
(12) Patent Application Publication
(10) Pub. No.: US 2014/0006974 A1
(43) Pub. Date: Jan. 2, 2014

(54) SELECTIVE SHARING OF WINDOWS AMONG PARTICIPANTS IN A WEB CONFERENCE

(71) Applicant: International Business Machines Corporation, Armonk, NY (US)

(72) Inventors: Denise A. Bell, Austin, TX (US); Lisa Seacat DeLuca, San Francisco, CA (US); Jana H. Jenkins, Raleigh, NC (US)

(73) Assignee: INTERNATIONAL BUSINESS MACHINES CORPORATION, Armonk, NY (US)

(21) Appl. No.: 13/911,394

(22) Filed: Jun. 6, 2013

Related U.S. Application Data
(63) Continuation of application No. 13/538,077, filed on Jun. 29, 2012.

(51) Int. Cl. H04L 29/06

(52) U.S. Cl. CPC H04L 65/403
USPC 715/753

(57) ABSTRACT

A Web conference is conducted. A first subset of a plurality of participants is designated in the Web conference. The first subset includes a first participant who is a presenter in the Web conference and at least a second participant, the first subset including less than a total number of the plurality of participants. First window content can be received, the first window content configured to be provided to each of the other participants of the web conference and configured to be presented in a first window. The first window content can be provided to each of the other participants. Second window content configured to be presented in a second window can be provided exclusively to each participant in the in the first subset of the plurality of participants.

### CROSS-REFERENCE TO RELATED APPLICATIONS

This application is a continuation of U.S. application Ser. No. 13/538,077, titled SELECTIVE SHARING OF WINDOWS AMONG PARTICIPANTS IN A WEB CONFERENCE, and filed Jun. 29, 2012, the entirety of which is fully incorporated herein by reference.

### BACKGROUND

The use of web conferencing and collaborative workspaces has grown significantly over the last decade, facilitated by the proliferation of communication networks, such as the Internet and mobile communication networks, and increases in available bandwidth. These services are valuable tools in the present communication age.

Web conferencing is a service that allows conferencing events to be shared with remote locations. In general, the service is made possible by Internet technologies, particularly on TCP/IP connections. Web conferencing allows real-time point-to-point communications as well as multicast communications from one sender to many receivers during a Web conference. Further, Web conferencing offers information, such as text-based messages, voice and video chat to be simultaneously shared across geographically dispersed locations. Applications for web conferencing include, but are not limited to, meetings, training events, lectures, or short presentations.

A collaborative workspace, also commonly referred to as a “shared workspace,” is an inter-connected environment in which participants in remote locations can access and interact with each other as though the users were working on a single system. Some collaborative workspace tools allow multiple users to simultaneously open, view and edit the same document during a collaborative session. Typically, a chat session or voice communications is used to facilitate communication between the users, for example to discuss suggestions, provide feedback, etc.

### BRIEF SUMMARY

One or more embodiments disclosed within this specification relate to selective sharing of windows among participants in a web conference. An embodiment can include a method of conducting a Web conference. The method can include designating a first subset of a plurality of participants in the Web conference, wherein the first subset includes a first participant who is a presenter in the Web conference and at least a second participant, the first subset including less than a total number of the plurality of participants. The method also includes receiving first window content configured to be provided to each of the other participants of the web conference and configured to be presented in a first window and, via a processor, providing the first window content to each of the other participants. The method further includes providing second window content configured to be presented in a second window exclusively to each participant in the in the first subset of the plurality of participants, wherein the second window does not obscure any portion of the first window when the first window is presented to participants who do not belong to the first subset.

### BRIEF DESCRIPTION OF THE SEVERAL VIEWS OF THE DRAWINGS

FIG. 1 is a block diagram illustrating operation of a Web conference in accordance with one embodiment disclosed within this specification.

FIG. 2 depicts a view of a first window in accordance with one embodiment disclosed within this specification.

FIG. 3 depicts a view of the first window and a second window in accordance with one embodiment disclosed within this specification.

FIG. 4 depicts a view of the first window, the second window and a third window in accordance with one embodiment disclosed within this specification.

FIG. 5 is a block diagram of a client device in accordance with one embodiment disclosed within this specification.

FIG. 6 is a block diagram of a server in accordance with one embodiment disclosed within this specification.

FIG. 7 is a flow chart illustrating a method of conducting a Web conference in accordance with one embodiment disclosed within this specification.

FIG. 8 is a flow chart illustrating a method of conducting a Web conference in accordance with one embodiment disclosed within this specification.

FIG. 9 is a flow chart illustrating a method of conducting a Web conference in accordance with one embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

Arrangements described herein relate to selective sharing of windows among users in a Web conference. As used herein, the term “Web conference” means a conferencing event that includes at least one video stream shared with a plurality of participants in dispersed locations and communicated over over one or more communication networks. As used herein, the term “collaborative workspace” means a computing environment supported over one or more communication networks in which a plurality of participants in dispersed locations access and interact with each other as though the participants were working on a single system. In one arrangement, a collaborative workspace allows multiple participants to simultaneously open, view and edit the same document during a collaborative session.

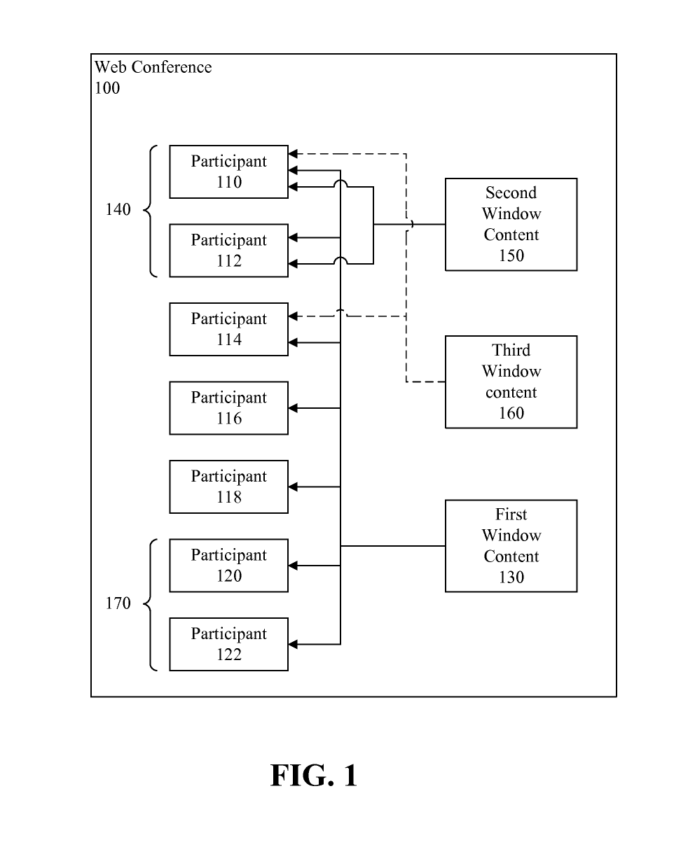

FIG. 1 is a block diagram illustrating operation of a Web conference 100 in accordance with one embodiment disclosed within this specification. A plurality of participants 110, 112, 114, 116, 118, 120, 122 can participate in the Web conference 100. Content for a first window (hereinafter “first window content” 130 or, more simply, “content” 130) via which the Web conference 100 is delivered can be received from a presenter, such as the participant 110. The first window content 130 can include any content suitably configured to be provided in a Web conference, such as text, images, video, illustrations, audio, etc. In illustration, the content 130 can include a presentation provided by the presenter for the web conference 100. The content 130 can include a streaming view of the presenter's desktop (e.g., on the presenter's client device), or a streaming view of content presented within one or more particular applications executed on the presenter's client device. In another arrangement, the desktop or application can be provided on a server to which the presenter's client device is communicatively linked.

A Web conference server can receive the content 130 from the presenter (e.g., the participant 110), and provide the content 130 to each of the other participants 112-122 in the web conference 100. The content 130 can be presented in a first window on each of the participants' 112-122 respective client devices. In the case that the desktop or application is provided on a server, the content 130 also can be provided to the participant 110, for example in a first window on the participant's 110 client device.

The Web conference 100 also can include one or more co-presenters, such as the participant 112, who also may provide at least a portion of the content 130. In this case, the Web conference server can receive such portion, and provide that portion of the content to the participants 110, 114-122. For example, the Web conference server can be suitably configured to merge various portions of the content 130 received from the first participant 110 and the second participant 112 into a single data stream, as may be appropriate, and provide this data stream to the participants 110-122.

A subset 140 of the plurality of participants 110-122 can be designated in the Web conference 100. The subset 140 can include the participant, such as the participant 110, who is the presenter in the Web conference 100 and one or more other participants, such as the one or more co-presenters (e.g., participant 112). In this regard, the subset 140 includes less than a total number of the participants 110-122. The subset 140 can be defined by an administrator, the presenter or the co-presenter, for example in a subset list (e.g. list of presenters) maintained by the Web conference server. Based on the subset list, the Web conference server can designate the participants 110-112 to be in the subset 140.

During the Web conference 100, participants 110-112 in the subset 140 may wish to privately share other content (hereinafter “second window content” 150 or, more simply, “content” 150), for example communications among one another, a collaborative workspace, other images, video, illustrations, audio, etc. The second window content 150 can be exclusively provided to the participants 110-112 in the subset 140 in a second window presented on their respective client devices. Thus, only the participants 110-112, at least initially, will have access to the content 150. The second window in which the content 150 is presented to the participants 110, 112 may at least partially obscure the first window in which the content 130 is presented on their respective client devices. Since the content 150 is not provided to participants 114-122 who are not in the subset 140, a second window would not be presented on their respective client devices, and thus would not obscure any portion of the first window as presented to those participants 114-122. In consequence, the other participants 114-122 need not be aware that the content 150 is being generated.

In illustration, if the content 130 includes a view of the participant's 110 desktop and/or the participant's 112 desktop, or a view of a desktop hosted by a server in which the participant 110 and/or participant 112 is working, the participant 110 and/or participant 112 can be provided an option to launch various applications in a hidden, or ghost, mode in which windows opened for or by such applications are only presented to the participants 110, 112, and not included in the content 130. For instance, such windows can be opened in a different desktop layer that is ignored when the content 130 is generated. Further, the content 130 can be provided in a first data stream from the participant 110 and/or the participant 112 to each of the other participants. The content 150 can be provided exclusively to the participant 112 from the participant 110 in a second data stream, or from the participant 112 exclusively to the participant 110. In the case that the content 150 is generated on the Web conference server, the Web conference server can provide the content 150 to the participants 110, 112 in a second data stream.

During the Web conference 100 a participant in the subset 140, for example the participant 110, may desire to communicate with another participant, such as the participant 114. The participant 110 can launch a third window to initiate communication with the participant 114. Initially, the third window need only be presented on the client device of the participant 110, and not on respective client devices of the other participants 112-122 in the Web conference 100. Accordingly, the third window would not obscure any portion of the first window as presented to participants 112-122, though it may obscure at least a portion of the first window and/or second window as presented to the participant 110, though this need not be the case. In illustration, if the content 130 includes a view of the participant's 110 desktop, or a view of a desktop hosted by a server in which the participant 110 is working, the participant 110 can be provided an option to launch various applications in a hidden, or ghost, mode in which windows opened for or by such applications are only presented to the participant 110, and not included in the content 130. For instance, such windows can be opened in a different desktop layer that is ignored when the content 130 is generated.

Upon the participant 110 generating and sending the additional content (hereinafter “third window content” 160 or, more simply, “content” 160) to the participant 114, the third window can be presented to the participant 114 on a respective client device to present the content 160. The third window content 160 can be, for example, a communication, such as an email or a text message. Accordingly, a private communication session can be established between the participant 110 and the participant 114. At this point, the third window may obscure at least a portion of the first window as presented to the participant 114 on a respective client device, though this need not be the case.

In one arrangement the content 160 can include a request to the participant 114 requesting that the participant 114 agree to receive the content 150. Responsive to the participant 114 agreeing, the subset 140 of participants can be expanded to include the participant 114, and the content 150 can be provided to the participant 114. For example, the participant 110 can add the participant 140 to the subset list. A second window in which the content 150 is presented may partially obscure at least a portion of the first window in which the content 150 is presented on the participant's 114 client device.

In another arrangement, the participant 114 may desire to communicate with the participant 110 and/or the participant 112. In this case, the participant 114 can launch a third window to initiate communication with the participant 110 and/or the participant 112. Initially, the third window need only be presented on the client device of the participant 114, and not to other participants, as previously described, until content 160 is sent, at which time the content 160 can be provided to the participant(s) 110,112. The third window presenting the content 160 may obscure at least a portion of the first window 130 as presented to the participant 114, and may obscure at least a portion of the first window and/or second window presented to the participant 110 and/or the participant 112, though this need not be the case.

In an arrangement in which the content 160 comprises a communication, the communication can include a request by the participant 114 to receive the content 150. For example, the participant can be an administrator who desires to provide input related the Web conference. Responsive to the participant 110 and/or the participant 112 authorizing sharing of the content 150 with the participant 114, the subset 140 can be expanded to include the participant 114, and the content 150 can be provided to the participant 114 for presentation to the participant 114 on the respective client device.

At some point during the Web conference 100 it may be desired to change presenters. In this case, a second subset 170 of the participants 110-122, which includes less than a total number of the participants 110-122, can be designated in the Web conference 100. For example, the presenter and co-presenter may be changed from the participants 110, 112 to the participants 120, 122. Accordingly, the subset 170 can include the participants 120, 122. In this case, subsequent to the content 150 having been provided to the first participants 110, 112, the content 150 can be provided to the participants 110, 112 in the subset 170. Further, in one non-limiting arrangement, providing of the content 150 to the participants 110, 112 in the subset 140 can be ceased when the transfer takes place. For example, second windows presented on the participants' 110, 112 client devices can be automatically closed upon the transfer taking place.

A private communication session, for instance similar to one already described, can be established between one or more participants 110, 112 of the subset 140 and one or more participants 120, 122 of the subset 170. For example, another private window (not shown) not provided to participants who are not in either of the subsets 140, 170 can be used for such communications. Via such communications, the participants 110, 112, 120, 122 can coordinate when the content 150 is to be transferred from the subset 140 to the subset 170. Responsive to such communication session, a participant 110, 112 in the subset 140 or a participant 120, 122 in the subset 170 can initiate transfer of the content 150, and the content 150 can be transferred from the first subset 140 of participants 110-122 to the second subset 170. In another arrangement, the content 150 can be automatically transferred from the first subset 140 to the subset 170 at a particular point in the presentation, or can be transferred based on a combination of pre-meeting and dynamic, real time, needs. In another arrangement, the content 150 can be automatically transferred in response to automatically identifying a participant in the second subset becoming an active speaker in the Web conference.

In another arrangement, in response to the first window content 130 changing, for example a new slide, illustration, video, etc. being presented in the Web conference 100, the first subset 140 can be updated in include one or more additional participants 114-122 and/or to remove one or more participants 110-112 from the first subset 140. Further, the first subset 140 can be updated in a similar manner responsive to the presenter being changed, for example the currently active presenter being changed from the participant 110 to the participant 120.

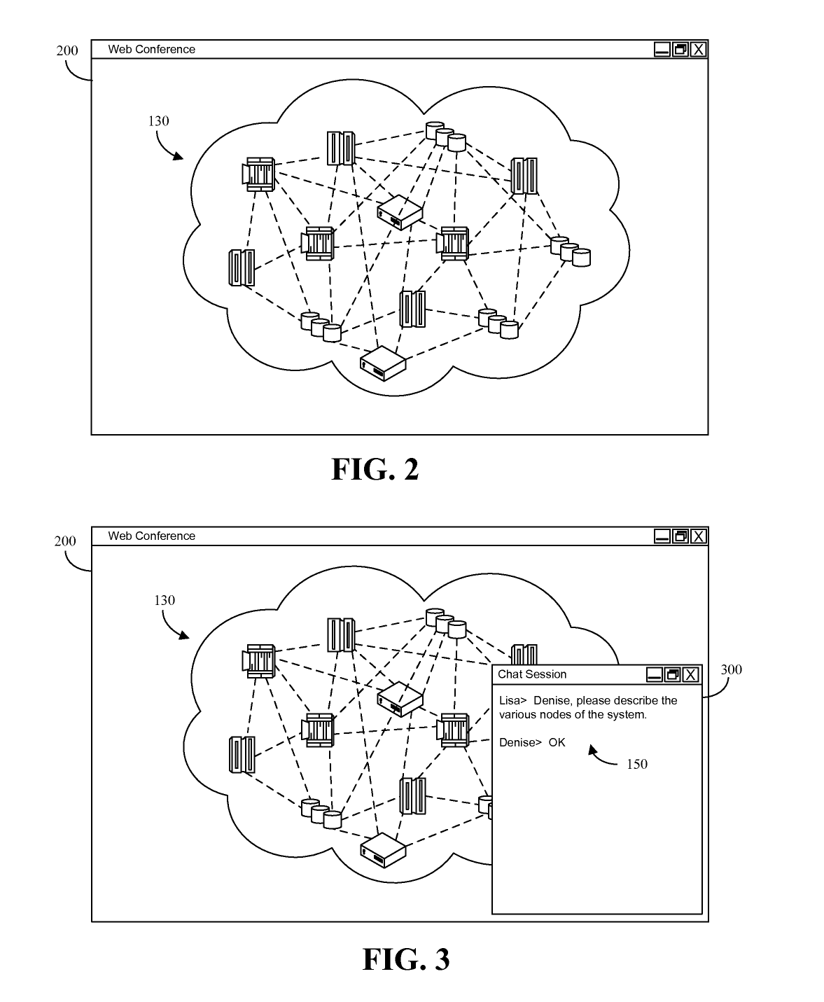

FIGS. 2, 3 and 4 now will be described with reference to the present arrangements. It is to be understood that specific content 130, 150, 160 depicted within the respective windows 200, 300, 400 shown in these figures is for illustration purposes only, and only are examples of content that can be provided in the respective windows 200, 300, 400. Accordingly, such examples of the content 130, 150, 160 are not to be considered to be limitations of the present invention.

FIG. 2 depicts a view of the first window 200 in accordance with one embodiment disclosed within this specification. The first window 200 can be presented to all participants in the Web conference on their respective client devices, and can include content 130 being presented in the Web conference. As other windows are provided to participants of the Web conference that belong to the subgroups described, the first window 200 can continue to be presented to all participants.

FIG. 3 depicts a view of the first window 200 and the second window 300 in accordance with one embodiment disclosed within this specification. As noted, the second window 300 can be presented to participants on within a subgroup on respective client devices when it is determined that the participants in such subgroup are to be provided the content 150. Participants who are not within such subgroup will not be presented the second window 300, and thus not be presented the content 150. As noted, the content 150 can include communications among members of the subgroup, a collaborative workspace, etc. As noted, the second window 300 may obscure at least a portion of the first window 200 for those participants who are provided the content 150, but participants who are not provided the second window 300 need not experience any corresponding obstruction.

In one arrangement, the content 130 can be provided in a first data stream to all participants, and the content 150 can be provided in a second data stream to participants in a respective subgroup. In another arrangement, a server can produce a bitmap (or other image) of a view comprising both the first window 200 and the second window 300, and provide this bitmap to the participants in the respective subgroup as the first and content 130, 150.

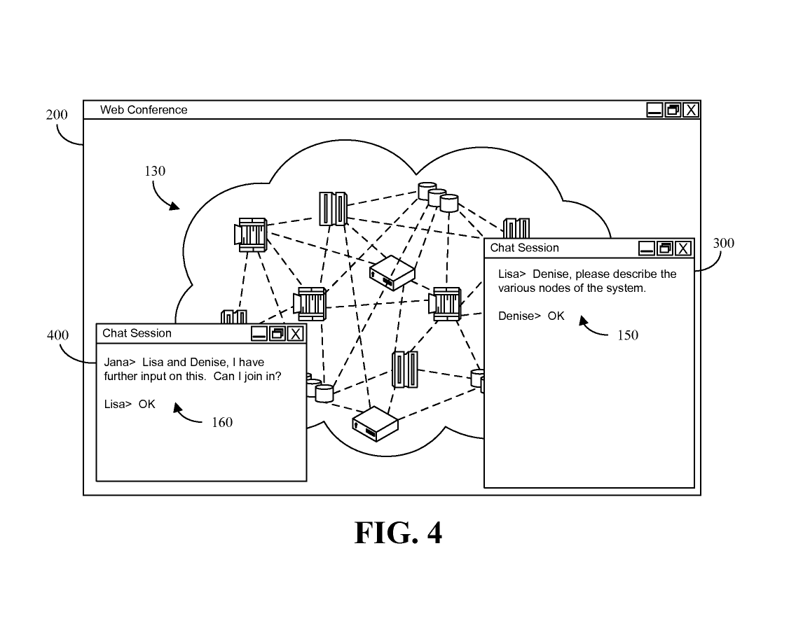

FIG. 4 depicts a view of the first window 200, the second window 300 and the third window 400 in accordance with one embodiment disclosed within this specification. The content 160 can be presented in the third window 400. As noted, the third window 400 can be presented, on respective client devices, to one or more participants within the subgroup and to a participant outside the subgroup who is communicating with the one or more participants. Other participants of the Web conference will not be provided the third window 400. As noted, the third window 400 may obscure at least a portion of the first window 200 for those participants who are provided the third window 400, but participants who are not provided the third window 400 need not experience any corresponding obstruction. For participants being provided the content 130, the content 150 and the content, the third window 400 may at least partially obscure the second window 300, though this need not be the case.

In one arrangement, the content 160 can be provided in a third data stream to intended participants. In another arrangement, a server can produce a bitmap (or other image) of the view comprising the content 130, the content 150, and the content 160, and provide this bitmap to the participants intended to receive such content.

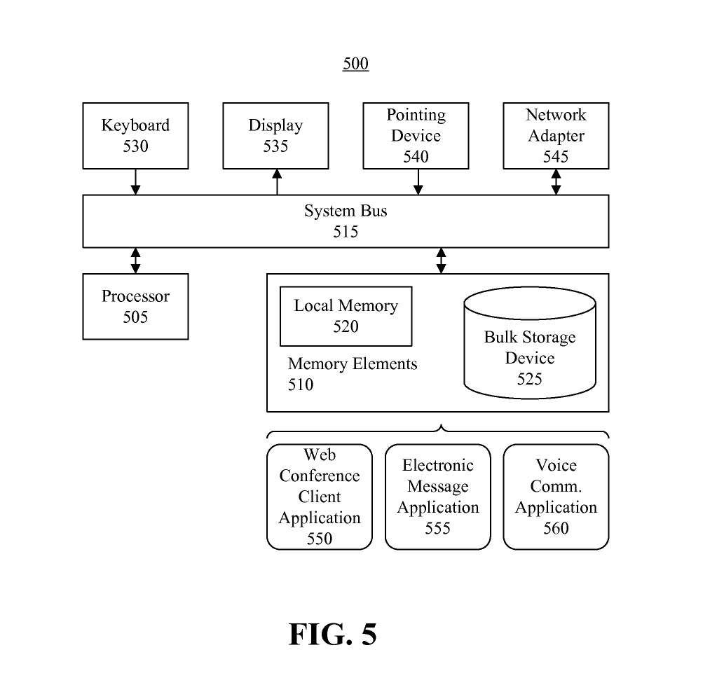

FIG. 5 is a block diagram of a client device 500 in accordance with one embodiment disclosed within this specification. The client device 500 represents an example of a client device that may be used by the various participants of the Web conference to participate in the Web conference and receive content for the various windows described. In this regard, as used within this specification and the claims that follow, providing content to a participant means providing content configured to be provided in a respective window depicted by a corresponding client device. Thus, when a server provides content, the server provides content to be provided in a window. The client device 500 receives such window content and depicts on a display a window comprising the content.

The client device 500 can be a computer, a mobile station (e.g., a laptop computer, a notebook computer, a tablet computer, a personal digital assistant, a mobile phone, etc.) or any other processing device suitably configured to support user participation in a Web conference. The client device 500 can include at least one processor 505 coupled to memory elements 510 through a system bus 515 or other suitable circuitry. As such, the client device 500 can store program code within the memory elements 510. The processor 505 can execute the program code accessed from the memory elements 510 via system bus 515. In one aspect, for example, the client device 500 can be implemented as a computer or other processing device that is suitable for storing and/or executing program code. It should be appreciated, however, that the client device 500 can be implemented in the form of any system including a processor and memory that is capable of performing the functions and/or operations described within this specification.

The memory elements 510 can include one or more physical memory devices such as, for example, local memory 520 and one or more bulk storage devices 525. Local memory 520 refers to RAM or other non-persistent memory device(s) generally used during actual execution of the program code. Bulk storage device(s) 525 can be implemented as a hard disk drive (HDD), solid state drive (SSD), or other persistent data storage device. The client device 500 also can include one or more cache memories (not shown) that provide temporary storage of at least some program code in order to reduce the number of times program code must be retrieved from the bulk storage device 525 during execution.

Input/output (I/O) devices such as a keyboard 530, a display 535, and a pointing device 540 optionally can be coupled to the client device 500. The I/O devices can be coupled to the client device 500 either directly or through intervening I/O controllers. One or more network adapters 545 also can be coupled to the client device 500 to enable the client device 500 to become coupled to other systems, computer systems, remote printers, and/or remote storage devices through intervening private or public networks. Modems, cable modems, and Ethernet cards are examples of different types of network adapters 545 that can be used with the client device 500.

As pictured in FIG. 5, the memory elements 510 can store a Web conference client application 550 (e.g., Web browser or other application suitably configured to receive and present a web conference), an electronic message application 555 (e.g., a text messaging client and/or an email client), and a voice communication application 560 (e.g., an application that supports Voice over IP (VoIP) communication). The Web conference client application 550, electronic message application 555 and voice communication application 560, being implemented in the form of executable program code, can be executed by the client device 500 and, as such, can be considered part of the client device 500.

The Web conference client application 550 can receive content for one or more windows during a Web conference, and present corresponding windows comprising the content on the display 535. In the case that the client device 500 is that of a presenter, the Web conference client application 550 also can generate the content.

The electronic message application 555 can send and receive electronic communications, such as instant messages and/or emails, and present corresponding windows on the display 535. In one non-limiting arrangement, the electronic message application 555 can be a component of the Web conference client application 550, thus supporting communications of electronic messages exclusively within the Web conference. In another arrangement, the electronic message application 555 can be configured to operate independently of the Web conference.

The voice communication application 560 can support voice communications among two or more participants within the Web conference. In one non-limiting arrangement, the voice communication application 560 also can be a component of the Web conference client application 550, thus supporting voice communications exclusively within the Web conference. In another arrangement, the voice communication application 560 can be configured to operate independently of the Web conference.

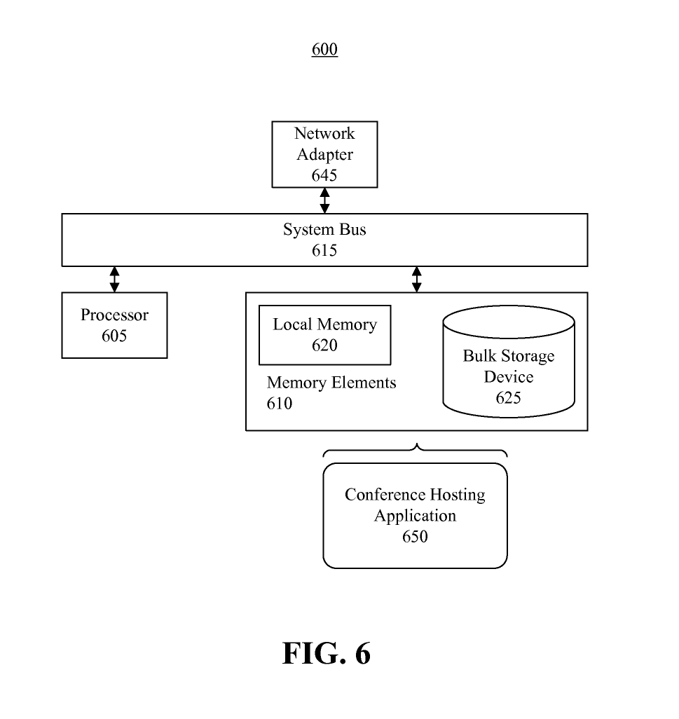

FIG. 6 is a block diagram of a web conference server (hereinafter “server”) 600 in accordance with one embodiment disclosed within this specification. In this regard, the server can provide content to the various participants of the Web conference.

The server 600 can include at least one processor 605 coupled to memory elements 610 through a system bus 615 or other suitable circuitry. As such, the server 600 can store program code within the memory elements 610. The processor 605 can execute the program code accessed from the memory elements 610 via system bus 615. In one aspect, for example, the server 600 can be implemented as a computer or other processing device that is suitable for storing and/or executing program code. It should be appreciated, however, that the server 600 can be implemented in the form of any system including a processor and memory that is capable of performing the functions and/or operations described within this specification.

The memory elements 610 can include one or more physical memory devices such as, for example, local memory 620 and one or more bulk storage devices 625. One or more network adapters 645 can be coupled to the server 600 to enable the server 600 to become coupled to other systems, computer systems, remote printers, and/or remote storage devices through intervening private or public networks. Modems, cable modems, and Ethernet cards are examples of different types of network adapters 645 that can be used with the server 600.

As pictured in FIG. 6, the memory elements 610 can store a conference hosting application 650. The conference hosting application 650, being implemented in the form of executable program code, can be executed by the server 600 and, as such, can be considered part of the server 600. The conference hosting application 650 can receive content presented in a Web conference, and stream the content to the participants of the web conference, as described within this specification.

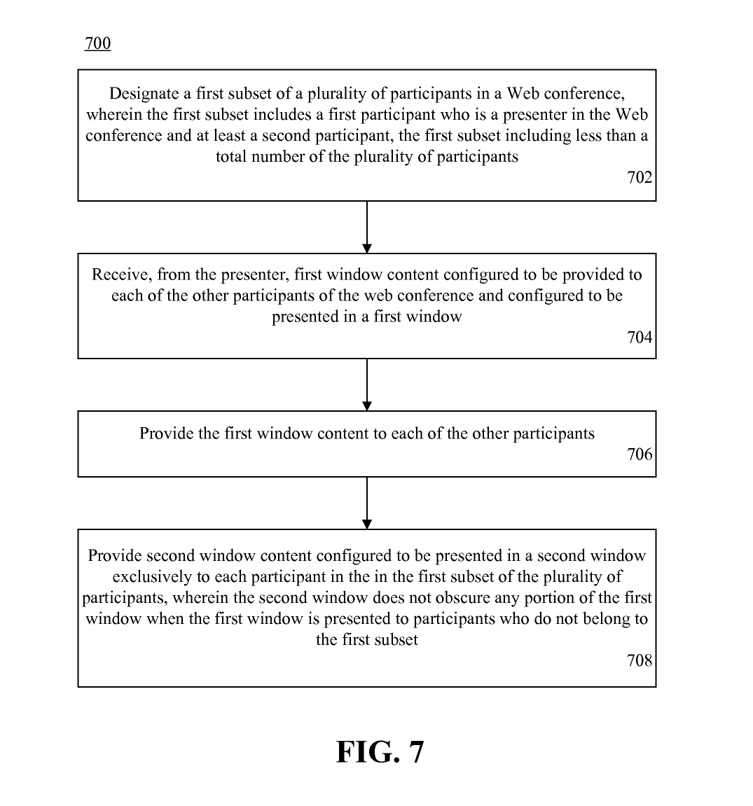

FIG. 7 is a flow chart illustrating a method 700 of conducting a Web conference in accordance with one embodiment disclosed within this specification. At step 702, a first subset of a plurality of participants in a Web conference can be designated. The first subset can include a first participant who is a presenter in the Web conference and at least a second participant, for example a co-presenter. The first subset includes less than a total number of the plurality of participants.

At step 704, first window content can be received from the presenter. The first window content can be configured to be provided to each of the other participants of the web conference and configured to be presented in a first window. At step 706, the first window content can be provided to each of the other participants. For example, if the first window content includes a view of the presenter's desktop, the first window content can be provided to each of the other participants. If the presenter is connected to a remote server and presenting the web conference from the remote server, the first window content also can be provided to the presenter (e.g., streamed from the server to the inventor's client device).

At step 708, second window content configured to be presented in a second window can be provided exclusively to each participant in the in the first subset of the plurality of participants. The second window does not obscure any portion of the first window when the first window is presented to participants who do not belong to the first subset. In one arrangement, the second window content can represent a collaborative workspace. In this case, access to the collaborative workspace can be provided exclusively to the first subset of the plurality of participants. In another arrangement, the second window content can convey communications among the first subset of the plurality of the participants. In this case, the communications are not available to participants who do not belong to the first subset of the plurality of the participants.

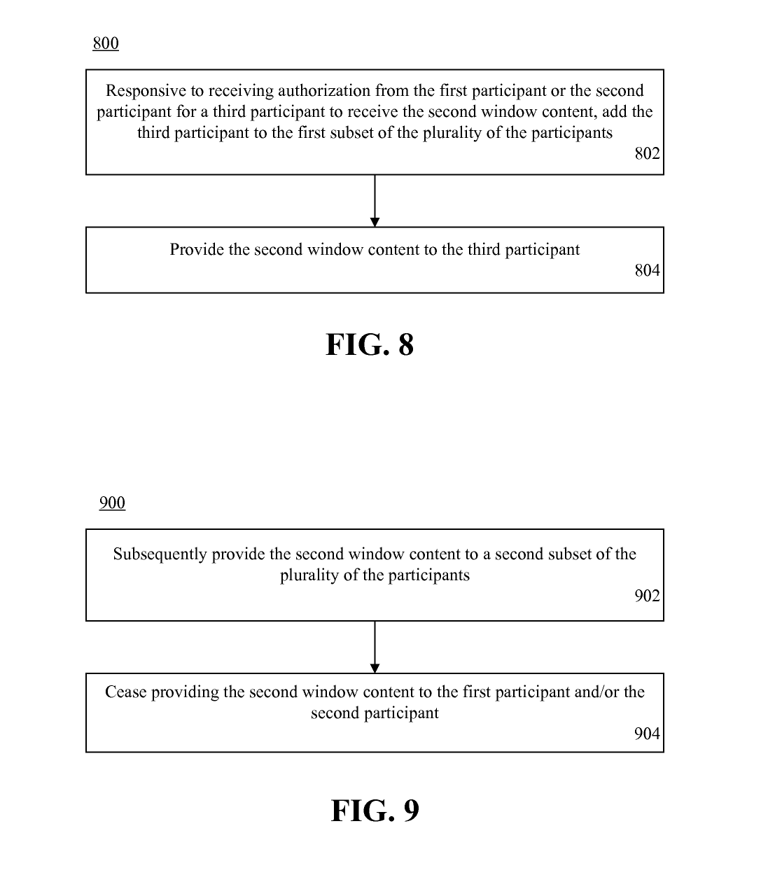

FIG. 8 is a flow chart illustrating a method 800 of conducting a Web conference in accordance with one embodiment disclosed within this specification. The method 800 can be implemented after step 708 of FIG. 7.

At step 802, responsive to receiving authorization from the first participant or the second participant for a third participant to receive the second window content, the third participant can be added to the first subset of the plurality of the participants. At step 804, the second window content can be provided to the third participant.

FIG. 9 is a flow chart illustrating a method 900 of conducting a Web conference in accordance with one embodiment disclosed within this specification. The method 900 can be implemented after step 708 of FIG. 7 or after step 804 of FIG. 8.

At step 902, the second window content can be subsequently provided to a second subset of the plurality of recipients. The second subset can include, for example, at least one participant who is a presenter in the Web conference. In one arrangement, the second window content can be provided to the second subset responsive to a private communication session being initiated between at least one participant in the first subset and at least one participant in the second subset. In another arrangement, the second window content can be provided to the second subset responsive to automatically identifying a participant in the second subset becoming an active speaker in the Web conference. In yet another arrangement, the second window content can be provided to the second subset responsive to automatically identifying at least one need for the Web conference, for example one or more pre-meeting and/or dynamic, real time, needs.

At step 904, providing of the second window content to the first participant and/or the second participant can be ceased.

Like numbers have been used to refer to the same items throughout this specification. The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

1. A method of conducting a Web conference, the method comprising:
designating a first subset of a plurality of participants in the Web conference, wherein the first subset includes a first participant who is a presenter in the Web conference and at least a second participant, the first subset including less than a total number of the plurality of participants;
receiving first window content configured to be provided to each of the other participants of the web conference and configured to be presented in a first window;
via a processor, providing the first window content to each of the other participants; and
providing second window content configured to be presented in a second window exclusively to each participant in the in the first subset of the plurality of participants, wherein the second window does not obscure any portion of the first window when the first window is presented to participants who do not belong to the first subset.

2. The method of claim 1, wherein the second participant is a co-presenter.

3. The method of claim 1, further comprising:
dynamically updating the first subset to add at least one participant to, or remove at least one participant from, the first subset responsive to the first window content changing.

4. The method of claim 1, further comprising:
dynamically updating the first subset to add at least one participant to, or remove at least one participant from, the first subset responsive to the presenter being changed from the first participant to the second participant or a third participant.

5. The method of claim 1, wherein the second window content represents a collaborative workspace, the method further comprising:
providing access to the collaborative workspace exclusively to the first subset of the plurality of the participants.

6. The method of claim 1, wherein:
the second window content conveys communications among the first subset of the plurality of the participants; and
the communications are not available to participants who do not belong to the first subset of the plurality of the participants.

7. The method of claim 1, further comprising:
responsive to receiving authorization from the first participant or the second participant for a third participant to receive the second window content, adding the third participant to the first subset of the plurality of the participants; and
providing the second window content to the third participant.

8. The method of claim 1, further comprising:
subsequently providing the second window content to a second subset of the plurality of the participants; and
ceasing providing the second window content to the first participant or the second participant.

9. The method of claim 8, wherein:
the second subset of the plurality of participants comprises at least a third participant who is a new presenter in the Web conference.

10. The method of claim 8, wherein:
subsequently providing the second window content to the second subset comprises providing the second window content to the second subset responsive to automatically identifying a participant in the second subset becoming an active speaker in the Web conference.

11-25. (canceled)
